(19) United States
(12) Patent Application Publication
(10) Pub. No.: US 2025/0269837 A1
(43) Pub. Date: Aug. 28, 2025

(54) TRAFFIC LIGHT STATE CONSENSUS DETERMINATION SYSTEMS AND METHODS

(71) Applicant: QUALCOMM Incorporated, San Diego, CA (US)

(72) Inventors: Alex Dytso, Princeton, NJ (US); Westley Thomas Gebauer, Carlsbad, CA (US); Mandar Narsinh Kulkarni, Bridgewater, NJ (US); Jubin Jose, Basking Ridge, NJ (US)

(21) Appl. No.: 18/590,293

(22) Filed: Feb. 28, 2024

(51) Int. Cl. B60W 30/00; B60W 50/00; B60W 60/00; G06T 7/90; G06V 10/778; G06V 20/58

(52) U.S. Cl. CPC B60W 30/00; B60W 50/0098; G06T 7/90; G06V 10/778; G06V 20/584; B60W 60/001; B60W 2420/403; B60W 2556/65; G06T 2207/10024; G06T 2207/20081; G06T 2207/30252

(57) ABSTRACT

This disclosure provides systems, methods, and devices for vehicle driving assistance systems that support image processing. In a first aspect, a method of image processing includes receiving image data indicative of respective states of a plurality of traffic lights; determining, using a machine learning model, noise information associated with the respective states; determining, using the machine learning model, a most probable state of the plurality of traffic lights based on the respective states; and determining, using the machine learning model, a consensus state of the plurality of traffic lights based on the noise information, the most probable state, and temporal information associated with the respective states of the plurality of traffic lights. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection. Various driving, or movement, assistance systems have also been produced in machine automation generally, such as in robotics.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

Example embodiments provide methods for determining a consensus on the status of a traffic light. For example, a traffic light can have different colors (e.g., green, yellow, red) and different shapes (e.g., circle, arrow, cyclist) that each have different durations, can be continuous or intermittent (e.g., flashing), and can have different durations between transitions than traffic lights at other intersections. The methods leverage an improved local model that incorporates temporal evolution of traffic lights thereby improving computational efficiency and adaptability to varying traffic light quantities. In this way, the improved local model is a reliable and versatile solution for accurate light color detection across diverse intersection settings. The methods also leverage distributed information across multiple vehicles at an intersection, and redundancy of information across traffic lights along high-definition (HD) map rules. The distributed information includes exchanging traffic light state estimates and pre-trained local models from the other vehicles when the local model on its own does not have sufficient data to be reliable.

In one aspect of the disclosure, a method for image processing includes receiving image data indicative of respective states of a plurality of traffic lights; determining, using a machine learning model, noise information associated with the respective states; determining, using the machine learning model, a most probable state of the plurality of traffic lights based on the respective states; and determining, using the machine learning model, a consensus state of the plurality of traffic lights based on the noise information, the most probable state, and temporal information associated with the respective states of the plurality of traffic lights.

In an additional aspect of the disclosure, an apparatus includes at least one processor and a memory coupled to the at least one processor. The at least one processor is configured to perform operations including a method of image processing includes receiving image data indicative of respective states of a plurality of traffic lights; determining, using a machine learning model, noise information associated with the respective states; determining, using the machine learning model, a most probable state of the plurality of traffic lights based on the respective states; and determining, using the machine learning model, a consensus state of the plurality of traffic lights based on the noise information, the most probable state, and temporal information associated with the respective states of the plurality of traffic lights.

In an additional aspect of the disclosure, a vehicle includes a plurality of cameras, at least one processor and a memory coupled to the at least one processor. The at least one processor is configured to perform operations including receiving, from the plurality of cameras, image data indicative of respective states of a plurality of traffic lights disposed in an environment around the vehicle; determining, using a machine learning model, noise information associated with the respective states; determining, using the machine learning model, a most probable state of the plurality of traffic lights based on the respective states; determining, using the machine learning model, a consensus state of the plurality of traffic lights based on the noise information, the most probable state, and temporal information associated with the respective states of the plurality of traffic lights; and controlling a function of the vehicle based on the consensus state that is determined.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system for determining a state of a plurality of traffic lights according to one or more aspects of the disclosure.

FIG. 5 is a flow diagram illustrating an example pipeline for determining a state of a plurality of traffic lights according to one or more aspects of the disclosure.

FIG. 6 is a flow diagram illustrating an example pipeline for a local determination of a state of a plurality of traffic lights according to one or more aspects of the disclosure.

FIG. 7 is a depiction of an intersection having traffic lights according to one or more aspects of the disclosure.

FIG. 8 is a flow chart illustrating an example method for determining a state of a plurality of traffic lights according to one or more aspects of the disclosure.

FIG. 9 is an illustrative block diagram of an example machine learning model represented by an artificial neural network.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support determining a consensus on the status of a traffic light. For example, a traffic light can have different colors (e.g., green, yellow, red) and different shapes (e.g., circle, arrow, cyclist) that each have different durations, can be continuous or intermittent (e.g., flashing), and can have different durations between transitions than traffic lights at other intersections. Conventional techniques for determining the status of a traffic light include the utilization of advanced computer vision and machine learning techniques, but the potential for misclassifications and/or a lack of availability caused by challenging lighting scenarios (e.g., obstructions or sun position) remains for these conventional techniques. For example, color consensus for a traffic light has conventionally been achieved only through local means (e.g., in-vehicle decisions), which exhibits a number of limitations, such as low adaptability, susceptibility to burst errors, and decision delay. Conventional attempts at building a local model (e.g., a linear regression model or neural network model) to predict traffic light duration typically fail because of the difficulty in obtaining an unbiased dataset that contains a few full cycles of normal operation of the traffic light. Simply aggregating local data of conventional methods from multiple vehicles using vehicle-to-vehicle (V2V) communications to obtain a dataset that contains a few full cycles of normal operation of the traffic lights, however, will only have a marginal detection reliability improvement since the local data itself suffers from low reliability.

Example embodiments of the present techniques more accurately determine a consensus on the status of a traffic light than conventional techniques. The present techniques leverage improved local temporal information in the vehicle, distributed information across multiple vehicles at an intersection, and redundancy of information across traffic lights along high-definition (HD) map rules. In various embodiments of the techniques, a method for determining a consensus agreement on the status of the traffic lights can include a local portion in which processing takes place locally, and a distributed portion which involves reaching consensus with the help of V2V communications. In such embodiments, the local portion and the distributed portion of the method operate jointly to reach the consensus on the state of a traffic light. The local portion includes a local model that incorporates temporal evolution of traffic lights and improves computational efficiency and adaptability to varying traffic light quantities, which contributes to the local model being a reliable and versatile solution for accurate light color detection across diverse intersection settings. The distributed portion leverages pre-trained local models from other vehicles when the local portion does not have sufficient data to be reliable.

Particular implementations of the subject matter described in this disclosure may be implemented to realize one or more of the following potential advantages or benefits. In some aspects, the present disclosure provides techniques for image processing that may be particularly beneficial in smart vehicle applications. For example, the present techniques enable more accurate tracking of traffic lights. One benefit of improved traffic light tracking is that it allows vehicle control systems to more accurately navigate vehicles through intersections having traffic lights. This is imperative for vehicle control systems to safely navigate the vehicles through these intersections, especially in urban areas having frequent intersections with traffic lights. In this way, improved traffic light tracking can help to improve overall safety on the roads by reducing vehicle collisions. With better traffic light tracking capabilities, vehicles can be made more responsive to a traffic light changing color so that the vehicles efficiently slow down and stop or accelerate at the correct moments. These improvements can also extend to driver assistance systems, which can benefit from increased monitoring capabilities. By improving the accuracy of traffic light state determination, these systems can offer more accurate alerts and assistance to drivers when necessary, without generating unnecessary notifications or distractions.

In another example, the present techniques are capable of capturing changing patterns of traffic lights over time, which facilitates dependable detection of light colors, even when observations are partially or entirely missing. In another example, the present techniques have the ability to utilize redundant information from multiple traffic lights and the multiple traffic lights' relationships in an HD map, which is achieved with lower computational complexity through a preprocessing step and a Viterbi algorithm. Both the preprocessing step and the Viterbi algorithm exhibit linear complexity in the number of states. Another example advantage of the present techniques is the ability to handle varying quantities of traffic lights, which renders the techniques suitable for most intersection scenarios.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

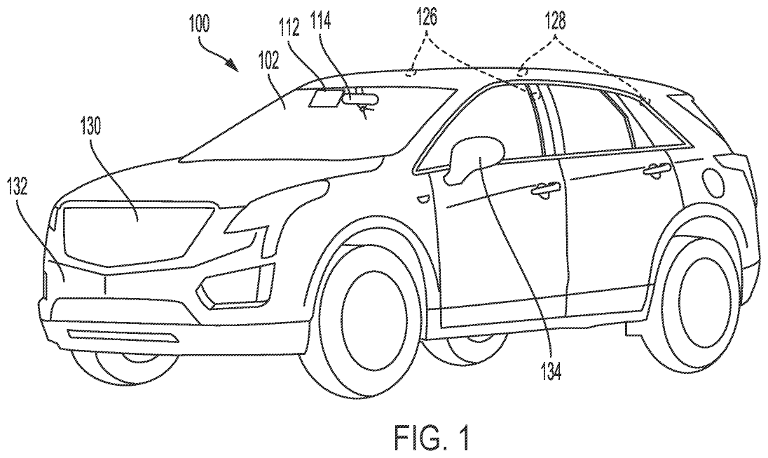

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

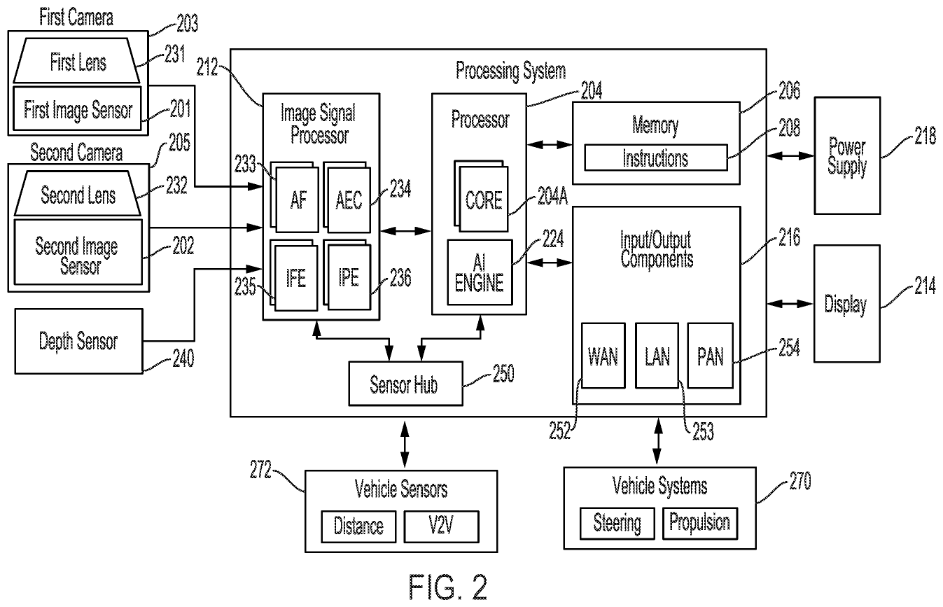

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

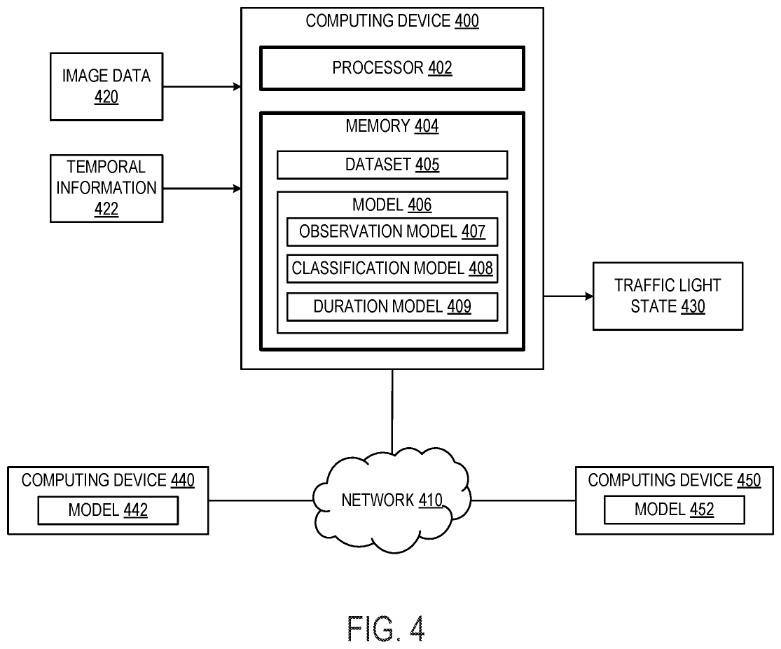

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIGS. 4-6, to determine the status of traffic lights in an environment around the vehicle 100 that can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

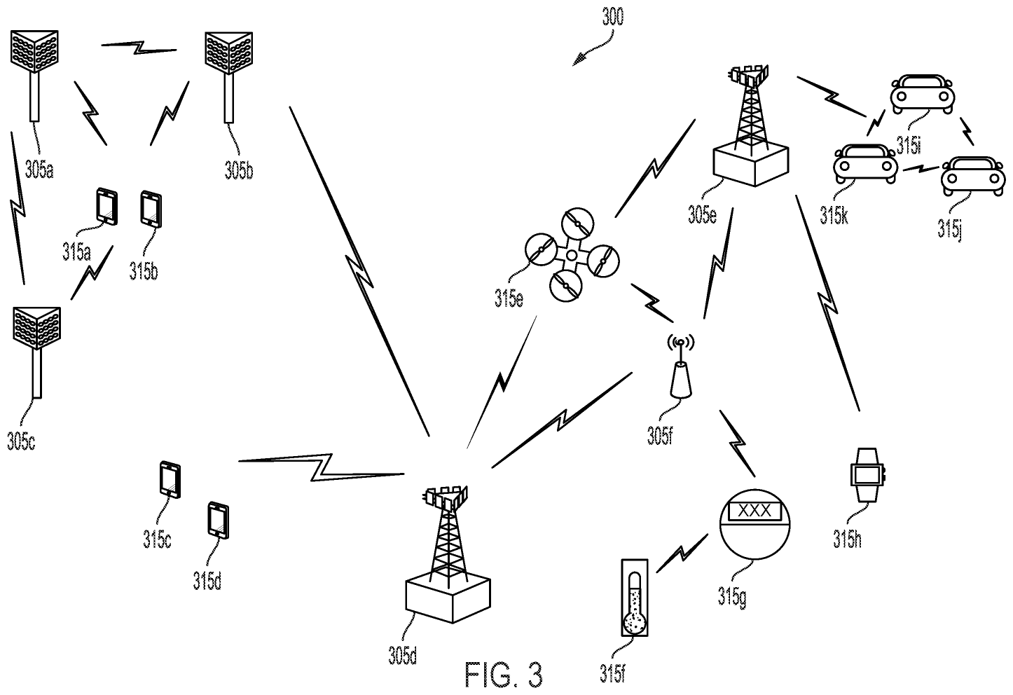

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 3151-315k communicating with macro base station 305e.

Aspects of the vehicular systems described with reference to, and shown in, FIG. 1, FIG. 2, and FIG. 3 may include techniques that support determining a consensus on the status of a traffic light. FIG. 4 is a block diagram illustrating an example computing device 400. Computing device 400 receives as input image data 420 and temporal information 422, and outputs a traffic light state 430. A traffic light follows a Markov model with the states red, yellow, and green. In an example, the red state can transition to the green state or to a not-available (NA) state, but not to the yellow state. The yellow state can transition to the red state or the NA state, but not to the green state; and, the green state can transition to the yellow state over the NA state, but not to the red state. The technique may operate under the assumption that the current state of a traffic light is solely dependent on the preceding state and does not rely on other prior states. Further, the technique may operate under the assumption that transitions between states happen with certain probability. An example state transition matrix is shown below including probabilities of each state transition, in which ‘p’, ‘q’, and ‘r’ each signify a different probability.

| | R | Y | G | NA |
|---|---|---|---|---|
| R | p | 0 | q | r |
| Y | q | p | 0 | r |
| G | 0 | q | p | r |
| NA | ¼ | ¼ | ¼ | ¼ |

The image data 420 is series of image frames captured by one or more cameras over a course of time. For example, three cameras on a vehicle may each capture a series of image frames over time as the vehicle drives through an environment. The temporal information 422 includes the specific times at which each of the image frames of the image data 420 was captured. Computing device 400 may be implemented by the image processing configuration of FIG. 2 or by one or more of the components illustrated in FIG. 3.

Computing device 400 includes a processor 402 (e.g., processor 204) coupled to a memory 404 (e.g., memory 206). In various aspects, processor 402 may include more than one processor. For example, processor 402 may include a first processor 402A (not shown) and a second processor 402B (not shown) that are each coupled to the memory 404. The first processor 402A may be in communication with the second processor 402B. The first processor 402A and the second processor 402B may each perform all of the operations performed by processor 402, or alternatively, the first processor 402A may only perform a first portion of the operations and the second processor 402B may only perform a second portion of the operations. In various aspects, memory 404 may include more than one memory. For example, memory 404 may include a first memory 404A (not shown) and a second memory 404B (not shown) that are each coupled to processor 402. The first memory 404A and the second memory 404B may each store all of the processor-executable code for all of the operations of processor 402, or alternatively, the first memory 404A may only store a first portion of the processor-executable code and the second memory 404B may only store a second portion of the processor-executable code.

In another example, processor 402 may include the first processor 402A and the second processor 402B that are each coupled to a first memory 404A (not shown) and a second memory 404B (not shown) of memory 404. In another example, processor 402 may include the first processor 402A coupled to the first memory 404A of memory 404, but not to the second memory 404B of memory 404, and the second processor 402B coupled to the second memory 404B, but not to the first memory 404B. In aspects in which processor 402 includes two or more processors, the two or more processors may be included with the same computing device 400, or may be suitably separated among two or more computing devices 400. In aspects in which memory 404 includes two or more memories, the two or more memories may be included with the same computing device 400, or may be suitably separated among two or more computing devices 400. The computing device(s) 400 with which the two or more memories of memory 404 are included may be the same computing device(s) 400 with which the at least one processor of processor 402 is included or may be different. For example, a processor 402 may be included with a first computing device 400A (not shown) and a memory 404 may be included with a second computing device 400B (not shown), e.g., a server, in communication with the first computing device 400A over a network.

The at least one memory 404 also stores a model 406. Model 406 is trained to output a consensus state of a plurality of traffic lights. In this way, model 406 predicts the traffic light state 430. For example, model 406 may be implemented as one or more machine learning models, including supervised learning models, unsupervised learning models, other types of machine learning models, and/or other types of predictive models. For example, model 406 may be implemented as one or more of a neural network, a transformer model, a decision tree model, a support vector machine, a Bayesian network, a classifier model, a regression model, and the like. For example, model 406 may include an observation model 407 trained to output noise information associated with image data indicative of a plurality of traffic lights, a classification model 408 trained to output a consensus state (e.g., color) of a plurality of traffic lights, and a duration model 409 trained to output a predicted duration of the state until the traffic lights transition to a different state. The predicted duration can also be referred to as a time to transition associated with a state.

Model 406 may be trained based on training data to determine the noise information, the consensus state, and the duration. For example, one or more training datasets (e.g., dataset 405 stored in memory 404) may be used that contain image frames depicting traffic lights of different colors and temporal information (e.g., start and end times) associated with the different colors. The training data sets may specify one or more expected outputs. For example, a color, duration, or end time. Parameters of model 406 may be updated based on whether model 406 generates correct outputs when compared to the expected outputs. In particular, model 406 may receive one or more pieces of input data from the training data sets that are associated with a plurality of expected outputs. Model 406 may generate predicted outputs based on a current configuration of model 406. The predicted outputs may be compared to the expected outputs and one or more parameter updates may be computed based on differences between the predicted outputs and the expected outputs. In particular, the parameters may include weights for different features and combinations of features (e.g., image data 420, temporal information 422). The parameter updates to model 406 may include updating one or more of the features analyzed and/or the weights assigned to different features or combinations of features (e.g., relative to the current configuration of model 406).

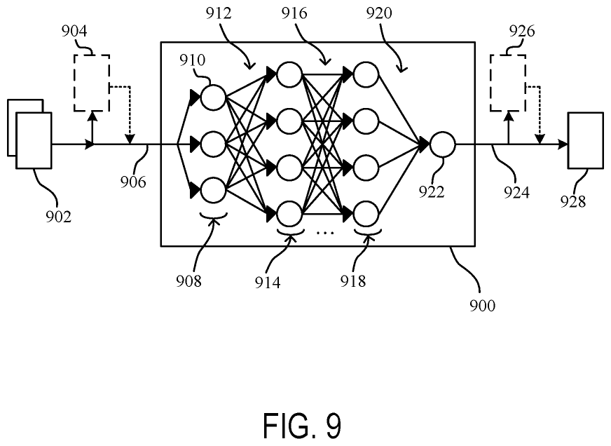

FIG. 9 is an illustrative block diagram of an example machine learning model (e.g., model 406) represented by an artificial neural network (ANN) 900. ANN 900 may receive input data 906 which may include one or more bits of data 902, pre-processed data output from pre-processor 904 (optional), or some combination thereof. Here, data 902 may include training data, verification data, application-related data, or the like, e.g., depending on the stage of deployment of ANN 900. Pre-processor 904 may be included within ANN 900 in some other implementations. Pre-processor 904 may, for example, process all or a portion of data 902 which may result in some of data 902 being changed, replaced, deleted, etc. In some implementations, pre-processor 904 may add additional data to data 902. In some implementations, the pre-processor 904 may be a machine learning model, such as an ANN.

ANN 900 includes at least one first layer 908 of artificial neurons 910 to process input data 906 and provide resulting first layer data via edges 912 to at least a portion of at least one second layer 914. Second layer 914 processes data received via edges 912 and provides second layer output data via edges 916 to at least a portion of at least one third layer 918. Third layer 918 processes data received via edges 916 and provides third layer output data via edges 920 to at least a portion of a final layer 922 including one or more neurons to provide output data 924. All or part of output data 924 may be further processed in some manner by (optional) post-processor 926. Thus, in certain examples, ANN 900 may provide output data 928 that is based on output data 924, post-processed data output from post-processor 926, or some combination thereof. Post-processor 926 may be included within ANN 900 in some other implementations. Post-processor 926 may, for example, process all or a portion of output data 924 which may result in output data 928 being different, at least in part, to output data 924, e.g., as result of data being changed, replaced, deleted, etc. In some implementations, post-processor 926 may be configured to add additional data to output data 924. In this example, second layer 914 and third layer 918 represent intermediate or hidden layers that may be arranged in a hierarchical or other like structure. Although not explicitly shown, there may be one or more further intermediate layers between the second layer 914 and the third layer 918. In some implementations, the post-processor 926 may be a machine learning model, such as an ANN.

The structure and training of artificial neurons 910 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process or during operation of the machine learning model. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into a machine learning model, an activation function allows the configuration for the machine learning model to change in response to identifying complex patterns and relationships in the input data 906 and determinations that should be made when those complex patterns and relationships are identified in the input data. Some non-exhaustive example activation functions include a sigmoid based activation function, a hyperbolic tangent (tanh) based activation function, a convolutional activation function, up-sampling, pooling, and a rectified linear unit (ReLU) based activation function.

Distributed or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device (e.g., vehicle) may receive a copy of all or part of a model and perform local training on such using locally available training data. Such a vehicle may provide update information regarding the locally trained model to one or more other vehicles (or a network entity or a server) where the updates from other-like vehicles may be aggregated and used to provide an update to a shared model or the like. A federated learning process may be repeated iteratively until all or part of a model obtains a satisfactory level of performance. Federated learning may enable vehicles to protect the privacy and security of local data, and reduce the bandwidth of communications between vehicles, while supporting collaboration regarding training and updating of all or part of a shared model.

Returning to FIG. 4, in some embodiments, computing device 400 may be in communication with a plurality of vehicles, such as a first vehicle including a computing device 440 and a second vehicle including a computing device 450, over a network 410. The network 410 may be any one of the networks previously described. The computing device 440 stores a model 442 and the computing device 450 stores a model 452. Each of the models 442 and 452 are similar to the model 406, except that the model 442 is locally trained based on training data that the first vehicle has accumulated and the model 452 is locally trained based on training data that the second vehicle has accumulated. The models 442, 452 may be implemented as one or more machine learning models, including supervised learning models, unsupervised learning models, other types of machine learning models, and/or other types of predictive models. For example, models 442, 452 may be implemented as one or more of a neural network, a transformer model, a decision tree model, a support vector machine, a Bayesian network, a classifier model, a regression model, and the like. A distributed learning scheme can support training and updated each of the models 406, 442, and 452.

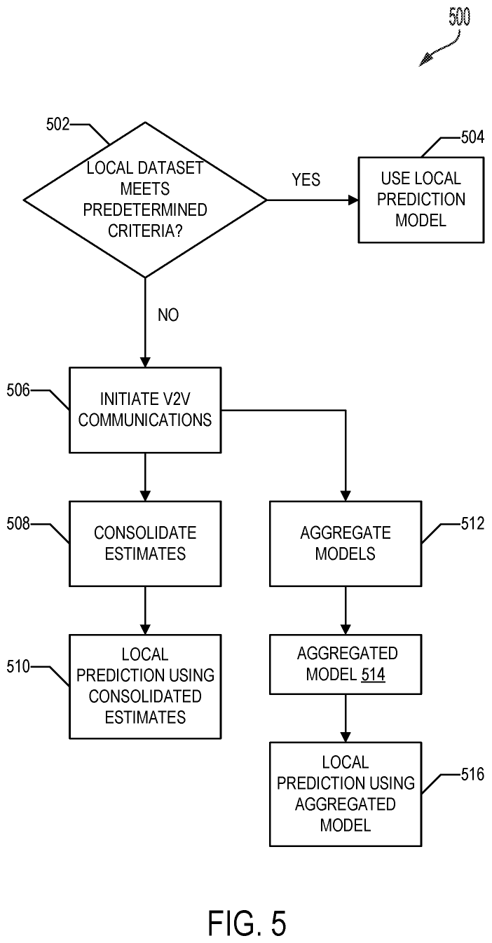

FIG. 5 is a flow diagram of an example pipeline 500 for determining a consensus state of a plurality of traffic lights. Pipeline 500 may include determining the consensus state locally (e.g., using the model 406 with the information available to computing device 400 of vehicle 100) or determining the consensus state with the aid of V2V communications and distributed learning. For example, pipeline 500 includes, at diamond 502, determining whether a local dataset (e.g., dataset 405) meets predetermined criteria. The predetermined criteria indicates whether the dataset 405 is sufficiently large for the model 406 to effectively and reliably train from the data set 405. For example, the predetermined criteria may be whether Equation 1 below is satisfied in which n is the quantity of unbiased samples in the dataset 405 and & is the desired accuracy subtracted from 1. For example, if the desired accuracy is 99%, then & is equal to 0.1, which means n must be greater than 320,000 unbiased samples for the dataset 405 to meet the predetermined criteria. Unbiased as used in this context means that the samples include examples of each of the colors green, yellow, and red including respective temporal information, and in some aspects, that the examples of green, yellow, and red are distributed according to the expected frequencies of green, yellow, and red. If the samples are biased (e.g., not unbiased), then the dataset 405 does not meet the predetermined criteria. For example, if an example of a single color is missing, then the dataset 405 is biased.

$$n > \frac{32}{{ε}^{2}} \qquad ( 1 )$$

If the dataset 405 meets the predetermined criteria, then pipeline 500 proceeds to block 504 at which a local prediction model (e.g., model 406) is used to determine a consensus state of a plurality of traffic lights. Local datasets, such as dataset 405, may not meet the predetermined criteria, however, because it is difficult for a single vehicle to observe and obtain data on a few full cycles of normal operation of a traffic light. For instance, the vehicle may drive through a green light and only observe a portion of the green light, or may pull up to a red light and make a right turn before the light turns green. The vehicle may repeatedly drive through an intersection, such as on a daily work commute, but it is still difficult for the vehicle to obtain enough data to train model 406 locally so that model 406 is reliable.

If the dataset 405 does not meet the predetermined criteria, then pipeline 500 proceeds to block 506 at which V2V communications are initiated. For example, computing device 400 receives messages broadcast by computing devices 440, 450 of other vehicles at an intersection. In some instances, each message includes an estimate of a state of the traffic light predicted by the local models 442, 452 of the respective computing devices 440, 450. For example, a message may include an estimated state and a confidence of the estimated state. At block 508, the received estimates are consolidated with an estimate determined by the model 406, and a single estimate of the state of the traffic light is determined. The consolidation takes the confidence information into account. For example, the consolidation include maximum likelihood decoding. Consolidated estimates utilizing boosting as described above can improve prediction accuracy over a prediction by the model 406 alone.

While boosting can improve prediction accuracy, the prediction accuracy can be improved further by boosting local model reliability. One approach to model training with V2V communication is to share the collected observation data. However, this can be prohibitively difficult from a communication standpoint because a vehicle must share not only local datasets but also datasets obtained from other vehicles. Even with a moderate quantity of cars, communication becomes a major bottleneck. The present techniques instead use a distributed version of the federated learning algorithm. For example, instead of transmitting the dataset 405 and datasets from other vehicles using V2V communication, the present techniques transmit the locally pretrained model 406. For example, in the case of a linear regression model, only the two parameters that define the linear regression model (e.g., slope and y-intercept) would need to be broadcast in a message instead of sending the entire dataset 405. Additionally or alternatively, the state transition matrix and the emissions matrix may be communicated, each of which always have the same size thereby resulting in consistently-sized communications. Effectively, the present techniques enable an amount of communication that is proportional to the quantity of cars and independent of the size of the collected datasets.

As such, in some instances, block 506 involves messages that include the local models 442, 452 of the respective computing devices 440, 450. In these instances, the computing device 400 can accept or reject one or both of the models 442, 452 that are received, such as based on a dictionary of models. In this example, models 442 and 452 are both dictionary compatible and therefore computing device 400 accepts both models 442 and 452. At block 512, computing device 400 aggregates the models 406, 442 and 452 to determine an aggregated model 514. In some embodiments, computing device 400 may aggregate the models 406, 442, and 452 by determining a weighted average of the parameters of the models 406, 442, and 452. For example, in the case of a linear regression model, all the slopes and y-intercepts are averaged into a single linear model. In other embodiments, computing device 400 may aggregate the models 406, 442, and 452 by determining a multivariate median (e.g., Tukey median) of the parameters of the models 406, 442, and 452. The aggregated model 514 may be declared as the true model. At the block 516, the aggregated model 514 is used by computing device 400 to determine a consensus state of the plurality of traffic lights.

Local datasets such as dataset 405 often do not meet the predetermined criteria because it is difficult for a single vehicle to observe and obtain data on a few full cycles of normal operation of a traffic light. For instance, the vehicle may drive through a green light and only observe a portion of the green light, or may pull up to a red light and make a right turn before the light turns green. The vehicle may repeatedly drive through an intersection, such as on a daily work commute, but it is still difficult for the vehicle to obtain enough data to train model 406 locally so that model 406 is reliable. The consolidated estimates and distributed learning gained by aggregating estimated states and broadcasted models from other vehicles at an intersection improves prediction confidence when model 406 is not sufficiently trained. Additionally, by broadcasting local models, rather than full datasets, message bandwidth is reduced. The message size increases only linearly with the quantity of cars and does not depend on the amount of data collected locally.

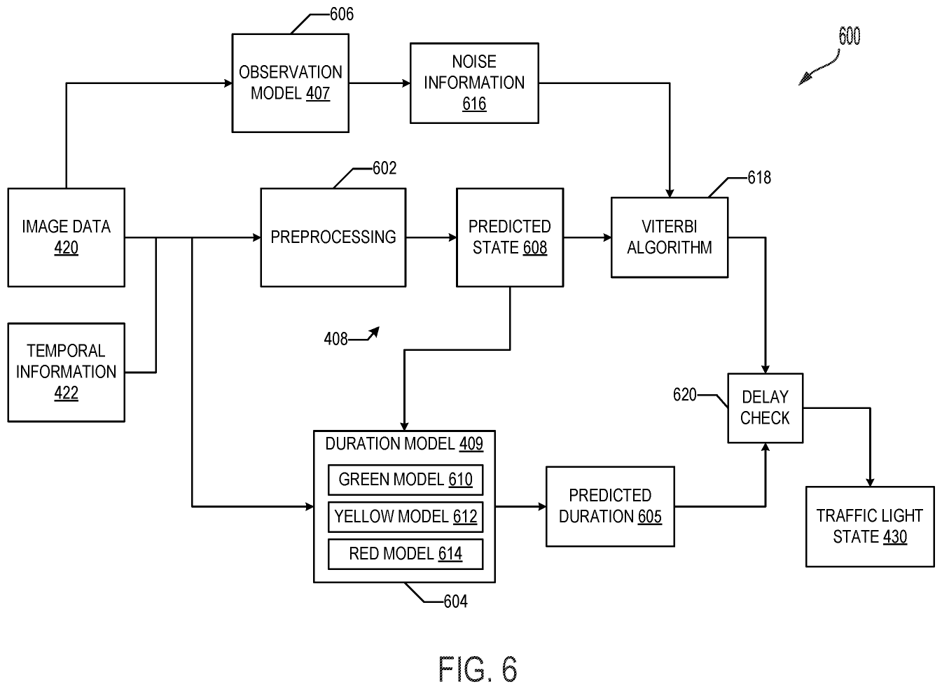

Whether the dataset 405 meets the predetermined criteria or not, a consensus state of a plurality of traffic lights is determined based on a local prediction process. FIG. 6 is a flow diagram of an example pipeline 600 for local prediction of a consensus state. Pipeline 600 includes inputting the image data 420 and temporal information 422 into model 406. For example, the image data 420 may be input into the observation model 407 of the model 406, and both the image data 420 and the temporal information 422 may be input into each of the classification model 408 and the duration model 409 of the model 406. At block 602, the classification model 408 includes preprocessing the image data 420 to reduce the plurality of observations of color of the plurality of traffic lights in the image data 420 to a single most probable state (e.g., predicted state 608) of the plurality of traffic lights along with a confidence of the most probable state. In various embodiments, the predicted state 608 (e.g., predicted color) may be determined from the plurality of observations of color in the image data 420 based on maximum likelihood decoding.

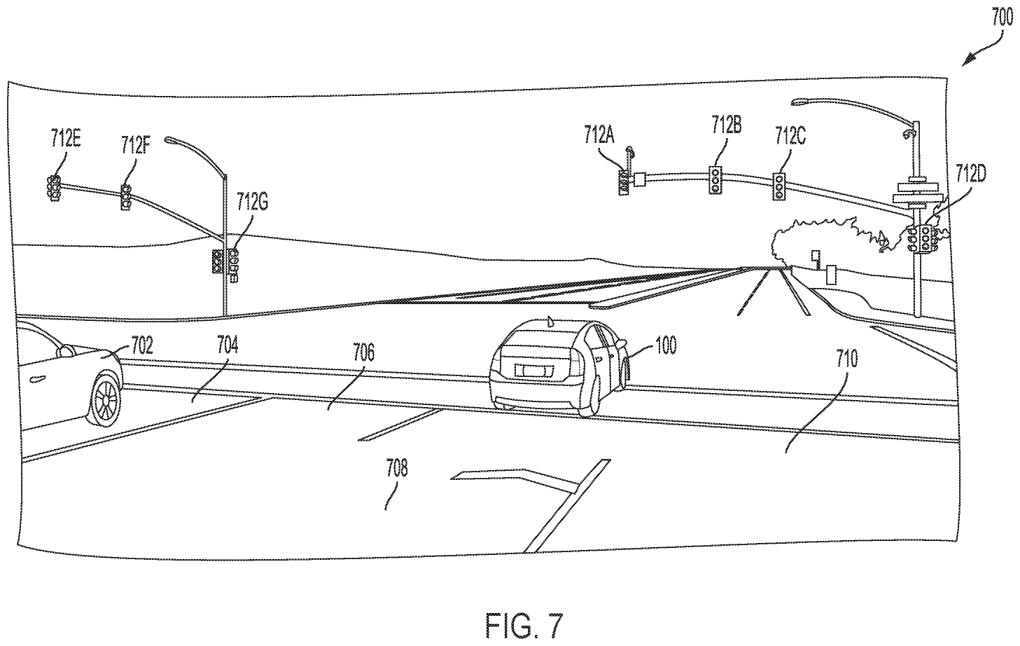

In some embodiments, information (e.g., the quantity of traffic lights at an intersection) can be obtained from an HD map and incorporated into the preprocessing, which improves computational complexity of the preprocessing. For example, FIG. 7 illustrates the vehicle 100 driving through an intersection 700 having a plurality of traffic lights 712A, 712B, 712C, 712D corresponding to the direction of travel of the vehicle 100 and a plurality of traffic lights 712E, 712F, 712G corresponding to a different direction of travel. An HD map can indicate that in the direction of travel of the vehicle 100, the road includes lanes 704, 706, 708, and 710, the traffic light 712A corresponds to the lane 704, and the traffic lights 712B, 712C, and 712D correspond to the lanes 706, 708, and 710. The HD map can further indicate that the lane 704 is a turn lane, whereas the lanes 706, 708, and 710 are lanes proceeding straight. The HD map can also indicate that each of the traffic lights 712E, 712F, and 712G corresponds to lanes oriented in a different direction of travel than the vehicle 100.

In this example, the traffic light 712A displays a red arrow and each of the traffic lights 712B, 712C, 712D display a green circle. For example, a vehicle 702 is stopped in the turn lane 704 because the traffic light 712 displays a red arrow, whereas the vehicle 100 is driving through a green light. Additionally, each of traffic lights 712E, 712F, 712G display red, whether an arrow or circle. When the vehicle 100 drives through the intersection 700, the vehicle 100 can detect all of the traffic lights 712A-712G. Based on the HD map, however, the vehicle 100 can disregard the traffic lights 712E, 712F, and 712G that correspond to a different direction of travel than the vehicle 100. Additionally, the vehicle 100 can disregard the traffic light 712A, or factor in that the traffic light 712A corresponds to the turn lane, based on the HD map. In this way, the HD map information can be useful for determining a traffic light state 430. In some embodiments, if an HD map is not available or the map information is noisy, a map provider can be notified. For example, the map information may be identified as noisy based on a prior failure of the model 406 to generate an output.

Returning to FIG. 6, at block 604, the predicted state 608 is input into the duration model 409. Considering that the colors of a traffic light have different durations, the duration model 409 includes a green model 610 trained to predict a duration of a green state, a yellow model 612 trained to predict a duration of a yellow state, and a red model 614 trained to predict a duration of a red state. The input predicted state 608 determines which of the green model 610, yellow model 612 and red model 614 is activated to predict a duration (e.g., time to transition) of the predicted state 608. For example, if the predicted state 608 includes the color green, then the green model 610 is activated. With the green model 610 activated, image data 420 and temporal information 422 are input into the green model 610 which outputs a predicted duration 605.

The models 610, 612, 614 may each be implemented as one or more machine learning models, including supervised learning models, unsupervised learning models, other types of machine learning models, and/or other types of predictive models. For example, models 610, 612, 614 may each be implemented as one or more of a neural network, a transformer model, a decision tree model, a support vector machine, a Bayesian network, a classifier model, a regression model, and the like. In an example, each of the models 610, 612, 614 is a regression model, the input variable used can be duration of the color transition and the regression variable can be the time to transition. In this example, the temporal information 422 includes the duration of the color transition and the time to transition. In other examples in which one or more of the models 610, 612, 614 is a more sophisticated model such as a neural network, the temporal information 422 input can be more complex and include additional information such as a time of day.

In at least some embodiments, to achieve accurate predicted durations 605, either the temporal information 422 must include the initial time that the traffic light transitioned to the current color or the green model 610, yellow model 612, or red model 614 can only be activated upon a transition between colors being observed. In some embodiments, the temporal information 422 can include the initial time of transition through receipt using V2V communications. For example, a first vehicle that observed the light transition to red can transmit the time of this transition to a second vehicle that pulls up to the intersection in the middle of the red light.

Additionally, considering that sets of traffic lights at different intersections, or even sets of traffic lights corresponding to different travel directions at a same intersection, can have different color durations, the green model 610, yellow model 612, and red model 614 are each trained for a particular plurality of traffic lights at a particular intersection. For example, for the plurality of traffic lights for vehicles traveling north at an intersection. As such, the duration model 409 includes a plurality of sets of green model 610, yellow model 612, and red model 614 with each set corresponding to a particular set of traffic lights. In various embodiments, an HD map may be used to associate a set of a green model 610, yellow model 612, and red model 614 with a set of traffic lights at a particular location. In this way, the set of the green model 610, yellow model 612, and red model 614 can be stored for later training when the vehicle 100 travels through the set of traffic lights at the particular location. For example, many vehicles make regular weekly trips (e.g., to work), and a given intersection can be tagged in the HD map so that training can be continued at the next occurrence of a given intersection.

At block 606, the observation model 407 determines noise information 616 that captures the influence of noise on the observations of traffic light color in the image data 420. These observations fall into one of four categories: red, yellow, green, or NA. When there are n traffic lights providing observations, there are a total of 4ⁿ potential observations (L₁, L₂, . . . Lₙ), with each Lᵢ having four potential states. The statistical framework that addresses the optimal detection of the Markov model state under uncertain observations is referred to as Hidden Markov Modeling (HMM). In the conventional HMM approach, an emissions matrix of noise transition probabilities is defined in addition to the state transition matrix. The emissions matrix includes a table that outlines the rates at which the traffic light might be inaccurately observed. The conventional HMM approach, however, lacks computational efficiency because a large table is often required to capture all of the transition probabilities, in part because the sequence in which traffic light colors appear is not given importance. For example, a quantity of traffic lights at an intersection can range from one to six, which requires a table size of up to 4096 cells. Additionally, the sequences of red to green and green to red are treated as distinct observations in the conventional HMM approach even though green to red is not possible.

In the present techniques, the noise information 616 includes a 4×4 emissions matrix having 16 cells that represent four probability mass functions: P(x|NA), P(x|red), P(x|yellow), and P(x|green). In this way, the present techniques improve computational efficiency over conventional approaches by reducing the number of cells that need to be managed in an emissions matrix. It is assumed in the present techniques that given a true color of a traffic light, noise acts independently on each traffic light. In this way, each cell in the emissions matrix is determined from a product distribution. For instance, for n=3, if the current state is S and three observations O1, O2, and O3 are observed, then P(O1, O2, O3|S)=P(O1|S)*P(O2|S)*P(O3|S). An example of the 4×4 emissions matrix is shown below, in which ‘a’ signifies the probability of staying in the same color, ‘b’ signifies the probability of switching to the wrong color, and ‘c’ signifies the probability of transitioning to NA.

| | R | Y | G | NA |
|---|---|---|---|---|
| R | a | b | b | c |
| Y | b | a | b | c |
| G | b | b | a | c |
| NA | b | b | b | a |

At block 618, the predicted state 608, the temporal information 422, and the noise information 616 are input into a Viterbi algorithm of the classification model 408. The Viterbi algorithm determines an output state that either confirms or corrects the predicted state 608. By inputting only the predicted state 608 rather than all of the color observations of image data 420 into the Viterbi algorithm, the complexity of running the Viterbi algorithm is reduced such that the time to output of the Viterbi algorithm is reduced. In some instances, however, the Viterbi algorithm can still take too long to determine an output despite the reduced complexity of the input.

At block 620, a delay check is performed to determine whether the Viterbi algorithm is causing too much delay, which would be a problem if a traffic light transitions to a new color and the classification model 408 is still processing the previous color. The delay check involves determining whether the time consumed by the Viterbi algorithm without having determined an output meets the predicted duration 605. If the time consumed by the Viterbi algorithm has not met the predicted duration 605, and the Viterbi algorithm has not determined an output, then more time is allowed for the Viterbi algorithm to process. If the Viterbi algorithm determines an output state that confirms the predicted state 608 prior to meeting the predicted duration 605, then the traffic light state 430 is determined to be the predicted state 608 with a confidence benefitting from confirmation by the Viterbi algorithm. If instead the Viterbi algorithm determines an output state that corrects the predicted state 608 prior to meeting the predicted duration 605, then the traffic light state 430 is determined to be the state output by the Viterbi algorithm with a confidence benefitting from the Viterbi algorithm. If the time consumed by the Viterbi algorithm meets the predicted duration 605, however, and the Viterbi algorithm has not determined an output, then the predicted state 608 output by the preprocessing is used as the traffic light state 430, but with a lower confidence than if the Viterbi algorithm had confirmed the predicted state 608.

In the above manner, the delay check balances the need for added confidence and the need for a timely decision. For instance, if the traffic light changes from green to yellow and the vehicle 100 maintains speed while waiting for confirmation that the light is green, the vehicle 100 may drive through a red light and potentially get in a collision or near collision. By resorting to the predicted state 608 if the Viterbi algorithm is taking too long, the classification model 408 is able to output timely traffic light states 430 which improves the safety of the vehicle 100.

The determined traffic light state 430 can be utilized for controlling a function of the vehicle 100. For example, the vehicle 100 can be controlled to drive, slow down, or stop based on the traffic light state 430 that is determined.

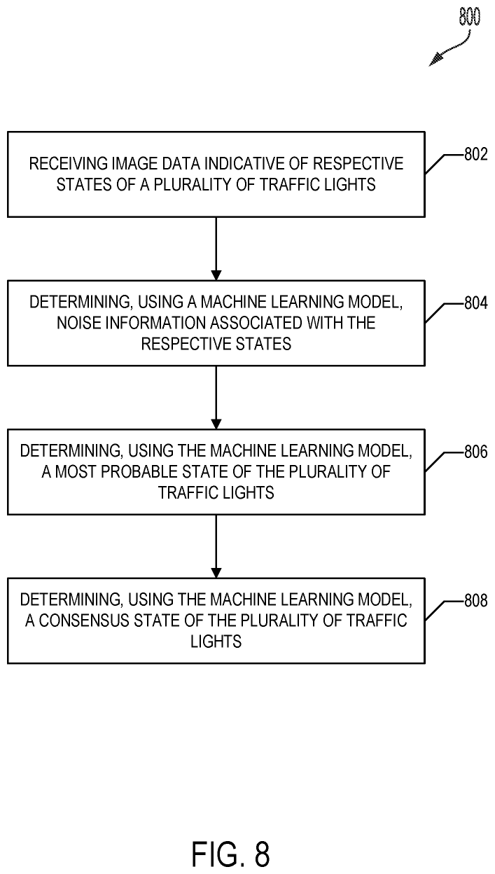

One method of performing image processing according to embodiments described above is shown in FIG. 8. FIG. 8 is a flow chart illustrating an example method 800 for determining a consensus state of a plurality of traffic lights. Method 800 includes, at block 802, receiving image data (e.g., image data 420) indicative of respective states of a plurality of traffic lights (e.g., traffic lights 412A-412D). A state of a traffic light of the plurality of traffic lights 412A-412D is indicative of a color or shape displayed by the traffic light.

At block 804, noise information (e.g., noise information 616) associated with the respective states is determined using a model (e.g., model 406). In various embodiments, the noise information 616 includes a state transition matrix and an emissions matrix.

At block 806, a most probable state (e.g., predicted state 608) of the plurality of traffic lights 412A-412D is determined using the model 406 and based on the respective states. For example, the predicted state 608 may be determined using the classification model 408 of the model 406. In some embodiments, the predicted state 608 is determined using maximum likelihood decoding.

At block 808, a consensus state (e.g., traffic light state 430) of the plurality of traffic lights 412A-412D is determined using the model 406 and based on the noise information 616, the predicted state 608) and temporal information (e.g., temporal information 422) associated with the respective states of the plurality of traffic lights 412A-412D. In some embodiments, the consensus state is determined based on inputting the most probable state, the noise information, and the temporal information into a Viterbi algorithm. For example, the Viterbi algorithm of the classification model 408. In some embodiments, the model 406 includes a duration model (e.g., green model 610, yellow model 612, red model 614) for each respective color of a traffic light of the plurality of traffic lights 412A-412D. In such embodiments, the method 800 may further include determining a predicted duration (e.g., predicted duration 605) of the predicted state 608 using the green model 610, yellow model 612, or red model 614 trained for the color associated with the predicted state 608. In such embodiments, the method 800 may further include determining that a duration of determining the consensus state meets the predicted duration 605 without the traffic light state 430 having been determine, and determining the traffic light state 430 as the predicted state 608.

In some embodiments, the method 800 includes receiving a plurality of models (e.g., models 442, 452) from a plurality of vehicles, and determining an aggregated model (e.g., aggregated model 514) based on the models 442, 452 that are received. In such embodiments, determining the aggregated model 514 may include determining a weighted average or a multivariate median of the models 442, 452. In some embodiments, the aggregated model 514 may be the model that is used in the method 800 instead of the model 406.

In some embodiments, the method 800 may further include controlling a function of the vehicle 100 based on the traffic light state 430. For example, the traffic light state 430 may be input to a driving assistance system that processes the traffic light state 430 to control functions of the vehicle 100.

It is noted that one or more blocks (or operations) described with reference to FIGS. 5, 6, and 8 may be combined with one or more blocks (or operations) described with reference to another of the figures. For example, one or more blocks (or operations) of FIGS. 5, 6, and 8 may be combined with one or more blocks (or operations) of FIG. 1-3. As another example, one or more blocks associated with FIGS. 5 and 6 may be combined with one or more blocks associated with FIG. 4.

In one or more aspects, techniques for supporting vehicular operations may include additional aspects, such as any single aspect or any combination of aspects described below or in connection with one or more other processes or devices described elsewhere herein. In a first aspect, an apparatus is configured to receive image data indicative of respective states of a plurality of traffic lights; determine, using a machine learning model, noise information associated with the respective states; determine, using the machine learning model, a most probable state of the plurality of traffic lights based on the respective states; and determine, using the machine learning model, a consensus state of the plurality of traffic lights based on the noise information, the most probable state, and temporal information associated with the respective states of the plurality of traffic lights. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, a state of a traffic light of the plurality of traffic lights is indicative of a color or shape displayed by the traffic light.

In a third aspect, in combination with one or more of the first aspect or the second aspect, the consensus state is determined based on inputting the most probable state, the noise information, and the temporal information into a Viterbi algorithm.

In a fourth aspect, in combination with one or more of the first aspect through the third aspect, the machine learning model includes a duration machine learning model for each respective color of a traffic light of the plurality of traffic lights, and the apparatus is further configured to determine a predicted duration of the most probable state using the duration machine learning model trained for the color associated with the most probable state.

In a fifth aspect, in combination with the fourth aspect, the apparatus is further configured to determine that a duration of determining the consensus state meets the predicted duration without the consensus state having been determined; and determine the consensus state as the most probable state.

In a sixth aspect, in combination with one or more of the first aspect through the fifth aspect, the apparatus is configured to receive a plurality of machine learning models from a plurality of vehicles; and determine an aggregated machine learning model based on the plurality of machine learning models that are received.

In a seventh aspect, in combination with the sixth aspect, determining the aggregated machine learning model includes determining a weighted average or a multivariate median of the plurality of machine learning models.

In an eighth aspect, in combination with the seventh aspect, the machine learning model is the aggregated machine learning model.

In a ninth aspect, in combination with one or more of the first aspect through the eighth aspect, the apparatus is further configured to control a function of a vehicle based on the consensus state.

In a tenth aspect, in combination with one or more of the second aspect through the ninth aspect, a method includes receiving image data indicative of respective states of a plurality of traffic lights; determining, using a machine learning model, noise information associated with the respective states; determining, using the machine learning model, a most probable state of the plurality of traffic lights based on the respective states; and determining, using the machine learning model, a consensus state of the plurality of traffic lights based on the noise information, the most probable state, and temporal information associated with the respective states of the plurality of traffic lights.

In an eleventh aspect, in combination with one or more of the second aspect through the ninth aspect, a vehicle includes a plurality of cameras, at least one processor and a memory coupled to the at least one processor. The at least one processor is configured to perform operations including receiving, from the plurality of cameras, image data indicative of respective states of a plurality of traffic lights disposed in an environment around the vehicle; determining, using a machine learning model, noise information associated with the respective states; determining, using the machine learning model, a most probable state of the plurality of traffic lights based on the respective states; determining, using the machine learning model, a consensus state of the plurality of traffic lights based on the noise information, the most probable state, and temporal information associated with the respective states of the plurality of traffic lights; and controlling a function of the vehicle based on the consensus state that is determined.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing, comprising:
receiving image data indicative of respective states of a plurality of traffic lights;
determining, using a machine learning model, noise information associated with the respective states;
determining, using the machine learning model, a most probable state of the plurality of traffic lights based on the respective states; and
determining, using the machine learning model, a consensus state of the plurality of traffic lights based on the noise information, the most probable state, and temporal information associated with the respective states of the plurality of traffic lights.

2. The method of claim 1, wherein a state of a traffic light of the plurality of traffic lights is indicative of a color or shape displayed by the traffic light.

3. The method of claim 1, wherein the consensus state is determined based on inputting the most probable state, the noise information, and the temporal information into a Viterbi algorithm.

4. The method of claim 1, wherein the machine learning model includes a duration machine learning model for each respective color of a traffic light of the plurality of traffic lights, the method further comprising:
determining a predicted duration of the most probable state using the duration machine learning model trained for the color associated with the most probable state.

5. The method of claim 4, further comprising:
determining that a duration of determining the consensus state meets the predicted duration without the consensus state having been determined; and
determining the consensus state as the most probable state.

6. The method of claim 1, comprising:
receiving a plurality of machine learning models from a plurality of vehicles; and
determining an aggregated machine learning model based on the plurality of machine learning models that are received.

7. The method of claim 6, wherein determining the aggregated machine learning model includes determining a weighted average or a multivariate median of the plurality of machine learning models.

8. The method of claim 7, wherein the machine learning model is the aggregated machine learning model.

9. The method of claim 1, further comprising controlling a function of a vehicle based on the consensus state.

10. An apparatus, comprising:
a memory storing processor-readable code; and
at least one processor coupled to the memory, the at least one processor configured to execute the processor-readable code to cause the at least one processor to perform operations including:
receiving image data indicative of respective states of a plurality of traffic lights;
determining, using a machine learning model, noise information associated with the respective states;
determining, using the machine learning model, a most probable state of the plurality of traffic lights based on the respective states; and
determining, using the machine learning model, a consensus state of the plurality of traffic lights based on the noise information, the most probable state, and temporal information associated with the respective states of the plurality of traffic lights.

11. The apparatus of claim 10, wherein a state of a traffic light of the plurality of traffic lights is indicative of a color or shape displayed by the traffic light.

12. The apparatus of claim 10, wherein the consensus state is determined based on inputting the most probable state, the noise information, and the temporal information into a Viterbi algorithm.

13. The apparatus of claim 10, wherein the machine learning model includes a duration machine learning model for each respective color of a traffic light of the plurality of traffic lights, the operations further including:
determining a predicted duration of the most probable state using the duration machine learning model trained for the color associated with the most probable state.

14. The apparatus of claim 13, the operations further including:
determining that a duration of determining the consensus state meets the predicted duration without the consensus state having been determined; and
determining the consensus state as the most probable state.

15. The apparatus of claim 10, wherein the operations include:
receiving a plurality of machine learning models from a plurality of vehicles; and
determining an aggregated machine learning model based on the plurality of machine learning models that are received.

16. The apparatus of claim 15, wherein determining the aggregated machine learning model includes determining a weighted average or a multivariate median of the plurality of machine learning models.

17. The apparatus of claim 16, wherein the machine learning model is the aggregated machine learning model.

18. A vehicle, comprising:
a plurality of cameras;
a memory storing processor-readable code; and
at least one processor coupled to the memory, the at least one processor in communication with the plurality of cameras and configured to execute the processor-readable code to cause the at least one processor to perform operations including:
receiving, from the plurality of cameras, image data indicative of respective states of a plurality of traffic lights disposed in an environment around the vehicle;
determining, using a machine learning model, noise information associated with the respective states;
determining, using the machine learning model, a most probable state of the plurality of traffic lights based on the respective states;
determining, using the machine learning model, a consensus state of the plurality of traffic lights based on the noise information, the most probable state, and temporal information associated with the respective states of the plurality of traffic lights; and
controlling a function of the vehicle based on the consensus state that is determined.

19. The vehicle of claim 18, wherein the operations include:
receiving a plurality of machine learning models from a plurality of vehicles; and
determining an aggregated machine learning model based on the plurality of machine learning models that are received.

20. The vehicle of claim 19, wherein the machine learning model is the aggregated machine learning model.
